(19) United States
(12) Patent Application Publication
(10) Pub. No.: US 2025/0072420 A1
(43) Pub. Date: Mar. 6, 2025

(54) METHOD FOR CONTROLLING WEEDS

(71) Applicant: SYNGENTA CROP PROTECTION AG, Basel (CH)

(72) Inventors: Roderick Justin BURKE, Fulbourn, Cambridgeshire (GB); Remi CHAUME, Guyancourt Cedex (FR)

(73) Assignee: SYNGENTA CROP PROTECTION AG, Basel (CH)

(21) Appl. No.: 18/724,780

(22) PCT Filed: Dec. 22, 2022
(86) PCT No.: PCT/EP2022/087645

§ 371 Date: Jun. 27, 2024

(30) Foreign Application Priority Data
Dec. 29, 2021 (EP) 21218052.5

(51) Int. Cl. A01N 37/02; A01N 25/06; A01N 37/40; A01N 43/40; A01N 43/66; A01N 43/90; A01P 13/00

(52) U.S. Cl. CPC A01N 37/02; A01N 25/06; A01N 37/40; A01N 43/40; A01N 43/66; A01N 43/90; A01P 13/00

(57) ABSTRACT

The present invention relates to a method of controlling dicot weeds at a locus with an aqueous spray composition comprising pelargonic acid and a second herbicide selected from fluroxypyr, aminopyralid, triclopyr, clopyralid, florasulam, flazasulfuron and prosulfuron; wherein the pelargonic acid is applied at a rate of 0.5 to 6 kg/ha.

This invention concerns a method for controlling the growth of undesirable vegetation including noxious weeds and invasive plants. In particular, the invention relates to a method of controlling the growth of undesired dicot plants with a herbicide composition comprising a combination of pelargonic acid with one or more selective herbicides.

The need for removal of unwanted plants and other undesirable vegetation such as noxious weeds and invasive plants is a constantly recurring problem in agriculture as well as in landscaped and industrial areas. For example, selectively removing problematic weeds and invasive species from roadsides, field roads, fencerows, utility corridors, areas around and between railways, airfields and other infrastructure and industrial areas often is desired to maintain safe rights-of-way, to clear signs and fixtures for visibility and functionality, to provide adequate drainage in roadway ditches, to reduce fire hazards and/or to slow or prevent the spread of noxious weeds.

To help combat and manage these vegetation problems, researchers in the field of synthetic chemistry have produced an extensive variety of chemicals and chemical formulations effective in the control of such unwanted growth. Chemical herbicides of many types have been disclosed in the literature and a large number are in commercial use. Commercial herbicides and some that are still in development are described, for example, in ‘The Pesticide Manual’, 19th Edition, published 2021 by the British Crop Protection Council.

The activity of herbicides can be enhanced in various ways to achieve the maximum benefit. One of the ways to enhance herbicidal efficacy is to use combinations. However, identifying the appropriate active ingredient combinations, application rates and spray water volumes to achieve extended broadleaf and brush weed control with reduced environmental loading is not straight forward.

Pelargonic acid, also called nonanoic acid, is a non-selective herbicide with structural formula CH₃(CH₂)₇CO₂H. The publication WO9105472 discloses herbicidal compositions comprising fatty acids such as pelargonic acid. The publication EP3245873B1 discloses certain herbicide combinations comprising pelargonic acid and at least one ALS inhibitor selected from iodosulfuron-methyl, foramsulfuron, mesosulfuron-methyl, flazasulfuron, amidosulfuron, ethoxysulfuron and thiencarbazone-methyl.

There remains a need for improved dicot weed control methods, in particular broadleaf and shrub control methods which reduce the amount of chemical herbicidal agent necessary to obtain acceptable weed control along with providing an increased residual herbicide activity.

In accordance with the present invention, it has now been discovered that the effectiveness of certain selective herbicides in the control of unwanted dicot plants is enhanced when co-applied with pelargonic acid at reduced rates.

Accordingly, the present invention provides a method of controlling or managing unwanted dicot plants by spray application of pelargonic acid in combination with at least one herbicide compound selected from the group consisting of a pyridyloxy-carboxylate-auxin mimic, an acetolactate synthase inhibitor, a carotenoid biosynthesis inhibitor and a benzoate-auxin mimic, wherein the pelargonic acid is applied at a rate of 0.5 to 6 kg/ha.

More specifically, the present invention provides a method for controlling unwanted dicot plants at a locus which comprises applying a dicot plant controlling amount of an aqueous spray composition to the locus, wherein the composition comprises pelargonic acid and at least one selective herbicide compound selected from the group consisting of a pyridyloxy-carboxylate-auxin mimic, an acetolactate synthase inhibitor, a carotenoid biosynthesis inhibitor and a benzoate-auxin mimic; wherein the water volume of the aqueous spray composition applied to the locus is from 100 to 500 l/ha and the pelargonic acid is applied to the locus at a rate of 0.5 to 6 kg/ha.

Embodiments according to the method of the invention are provided as set out below.

In one embodiment, the water volume of the aqueous spray composition applied to the locus is from 100 to 500 l/ha; in another embodiment, the water volume of the aqueous spray composition applied to the locus is from 200 to 400 l/ha.

In another embodiment, the water volume of the aqueous spray composition applied to the locus is 200 l/ha; In another embodiment, the water volume of the aqueous spray composition applied to the locus is 400 l/ha.

In one embodiment, in accordance with the method of the present invention, the non-selective herbicide pelargonic acid is applied to the locus at a rate of 0.5 to 6 kg/ha. In other embodiments, pelargonic acid is applied to the locus at a rate of from 0.5-1.2 kg/ha; or from 1-1.7 kg/ha; or from 1.5-3 kg/ha; or from 2-3 kg/ha; or from 1.7-6 kg/ha; or from 2 to 6 kg/ha, or from 3 to 6 kg/ha. In a preferred embodiment, pelargonic acid is applied to the locus at a rate of 1.7-6 kg/ha.

In another preferred embodiment, the pelargonic acid is applied to the locus at a rate of 1.6-6 kg/ha, or from 1.7-6 kg/ha and the water volume of the aqueous spray composition applied to the locus is 200 l/ha.

In another preferred embodiment, the pelargonic acid is applied to the locus at a rate of 2-6 kg/ha and the water volume of the aqueous spray composition applied to the locus is 200 l/ha.

In another preferred embodiment, the pelargonic acid is applied to the locus at a rate of 2.8-6 kg/ha or from 3-6 kg/ha and the water volume of the aqueous spray composition applied to the locus is 200 l/ha.

Also preferred is a method when the pelargonic acid is applied to the locus at a rate of 1.6-6 kg/ha or from 1.7-6 kg/ha and the water volume of the aqueous spray composition applied to the locus is 400 l/ha.

Further preferred is when the pelargonic acid is applied to the locus at a rate of 2-6 kg/ha and the water volume of the aqueous spray composition applied to the locus is 400 l/ha.

In another preferred embodiment, the pelargonic acid is applied to the locus at a rate of 2.8-6 kg/ha or from 3-6 kg/ha and the water volume of the aqueous spray composition applied to the locus is 400 l/ha.

In one embodiment, the pyridyloxy-carboxylates-auxin mimic compound used in the method of the invention is selected from fluroxypyr, aminopyralid, triclopyr and clopyralid; preferably fluroxypyr, aminopyralid, and triclopyr. In other embodiments, fluroxypyr is formulated as the 1-methylheptyl ester (fluroxypyr-meptyl) and is applied to the locus at a rate of 196-200 g/ha; aminopyralid is applied to the locus at a rate of 48-50 g/ha; triclopyr is applied to the locus at a rate of 120 g/ha, preferably 400-480 g/ha; and clopyralid is applied to the locus at a rate of 160 g-200 g/ha. In other embodiments, the rates of aminopyralid and triclopyr are assessed on the basis of g ae (grams acid equivalent).

In another embodiment, the acetolactate synthase inhibitor used in the method of the invention is selected from florasulam, flazasulfuron and prosulfuron, preferably florasulam and prosulfuron. In one embodiment, florasulam is applied to the locus at a rate of 4.9-50 g/ha, preferably 4-6 g/ha; flazasulfuron is applied to the locus at a rate of 50 g/ha; and prosulfuron is applied to the locus at a rate of 15-20 g/ha.

Also preferred for use in the method of the invention is a carotenoid biosynthesis inhibitor selected from diflufenican. In another embodiment, diflufenican is applied to the locus at a rate of 75 g to 280 g/ha.

In a further embodiment, the benzoate-auxin mimic used in the method of the invention is selected from dicamba. In another embodiment, dicamba is applied to the locus at a rate of 150-200 g/ha

In a preferred embodiment of the present invention, the method for controlling unwanted dicot plants at a locus comprises applying a dicot plant controlling amount of an aqueous spray composition to the locus, wherein the composition comprises pelargonic acid and at least one selective herbicide compound selected from the group consisting of fluroxypyr, aminopyralid, triclopyr, clopyralid, florasulam, flazasulfuron, prosulfuron, diflufenican and dicamba, preferably fluroxypyr-meptyl, aminopyralid, triclopyr, florasulam, prosulfuron, diflufenican and dicamba; wherein the spray volume of the aqueous spray composition applied to the locus is from 100 to 500 l/ha, preferably 200 to 400 l/ha; and the pelargonic acid is applied to the locus at a rate of 0.5 to 6 kg/ha; preferably 1.6-6 kg/ha; more preferably 1.7-6 kg/ha; also preferred is when the pelargonic acid is applied to the locus at a rate of 2.8-6 kg/ha or 3-6 kg/ha.

In a further preferred embodiment of the present invention, the method for controlling unwanted dicot plants at a locus comprises applying a dicot plant controlling amount of an aqueous spray composition to the locus, wherein the composition comprises pelargonic acid and at least one selective herbicide compound selected from the group consisting of fluroxypyr, aminopyralid, triclopyr, clopyralid, florasulam, flazasulfuron and prosulfuron, preferably fluroxypyr-meptyl, aminopyralid, triclopyr, florasulam, prosulfuron, diflufenican and dicamba; wherein the spray volume of the aqueous spray composition applied to the locus is from 100 to 500 l/ha, preferably 200 to 400 l/ha; and the pelargonic acid is applied to the locus at a rate of 0.5 to 6 kg/ha; preferably 1.6-6 kg/ha; more preferably 1.7-6 kg/ha; more preferably 2.8-6 kg/ha. Also preferred is when the pelargonic acid is applied to the locus at a rate of 2.8-6 kg/ha or 3-6 kg/ha.

Also preferred is when the method for controlling unwanted dicot plants at a locus comprises applying a dicot plant controlling amount of an aqueous spray composition to the locus, wherein the composition comprises pelargonic acid and at least one selective herbicide compound selected from the group consisting of fluroxypyr and florasulam; wherein the spray volume of the aqueous spray composition applied to the locus is from 100 to 500 l/ha, preferably 200 to 400 l/ha; and the pelargonic acid is applied to the locus at a rate of 1.6-6 kg/ha; preferably 1.7-6 kg/ha; more preferably 2.8-6 kg/ha. Also preferred is when the pelargonic acid is applied to the locus at a rate of 3-6 kg/ha.

Suitable weight ratios of the pelargonic acid and the at least one selective herbicide compound are found, for example, by the above-noted application rates for the individual compounds. In the method according to the invention, the application rates of pelargonic acid are reduced relative to standard pelargonic acid application rates for weed control. In one embodiment, mixing ratios of the pelargonic acid (PA) and the 5 at least one selective herbicide compound (SH) according to the invention in the inventive method are, for example: PA:SH of from 2:1 to 1200:1; or from 10:1 to 120:1. As noted, other ratios will be apparent to those skilled in the art based on the above-noted application rates and the herbicide concentrations in suitable commercial formulations used to prepare aqueous spray formulations to be used in the method of the invention.

In a preferred embodiment, the selective herbicide compound used in the aqueous spray composition comprises fluroxypyr. Also preferred is when the selective herbicide compound used in the aqueous spray composition comprises florasulam.

In another preferred embodiment, the selective herbicide compound used in the aqueous spray composition comprises prosulfuron. Also preferred is when the selective herbicide compound used in the aqueous spray composition comprises dicamba. Also preferred is when the selective herbicide compound used in the aqueous spray composition comprises flazasulfuron.

In another preferred embodiment, the selective herbicide compound used in the aqueous spray composition comprises aminopyralid. Also preferred is when the selective herbicide compound used in the aqueous spray composition comprises triclopyr.

In one embodiment, the pelargonic acid is in unhydrolyzed form.

In another embodiment, the aqueous spray composition used in the method of the invention comprises pelargonic acid and mixtures of the at least one herbicide compound selected from the group consisting of a pyridyloxy-carboxylate-auxin mimic, an acetolactate synthase inhibitor, a carotenoid biosynthesis inhibitor and a benzoate-auxin mimic are. In a specific embodiment, when mixtures are used in the aqueous spray composition, binary or ternary mixtures of such herbicide compounds are used. In a preferred embodiment, the aqueous spray composition used in the method of the invention comprises pelargonic acid and a mixture of fluroxypyr and florasulam, or fluoroxypyr-meptyl and florasulam. In another preferred embodiment, the aqueous spray composition comprises pelargonic acid and a mixture of dicamba and prosulfuron, or a mixture of prosulfuron, dicamba and diflufenican. In a further embodiment, the aqueous spray composition used in the method comprises pelargonic acid and a mixture of aminopyralid and triclopyr.

The term “locus” means the area in which the dicot plants have emerged, are growing, or are established. Thus, in the context of the invention, the locus will typically be a non-crop area where vegetation management may be required including amenity grassland, paths, utilities, roadsides, railroads, highways, airports, associated rights of way, field roads, fencerows, cleaning pathways between soil-bound pots, facilities for storing or distributing products, bare ground and other infrastructure or industrial areas.

For example, an infrastructure or industrial area locus may include facilities for manufacturing or processing, mines, well sites, equipment yards and other facilities for or ancillary to energy production or resource extraction, transmission lines, power stations, electric utilities (substations, switching stations, transmission lines, and distribution lines), pipelines and pumping stations, and other soft or hard surfaces or areas where invasive dicot broadleaf weeds, brush, bramble, shrubs and woody weeds may occur. In the context of the present invention, although the locus may further comprise other types of plants, weeds or vegetation, the present invention is directed to a method for controlling the unwanted dicot plants that are present in such locus including emerged, growing as well as established vegetation.

The term ‘herbicide’ as used herein denotes an active ingredient compound which controls or modifies the growth of plants. The term ‘dicot plant controlling amount’ indicates the quantity of an aqueous spray composition containing pelargonic acid and at least one selective herbicide compound selected from the group consisting of a pyridyloxy-carboxylate-auxin mimic, an acetolactate synthase inhibitor, a carotenoid biosynthesis inhibitor and a benzoate-auxin mimic or combination of such compounds which can produce a controlling or modifying effect on the growth of diquat plants. Preferably, the term ‘dicot plant controlling amount’ indicates the quantity of an aqueous spray composition containing pelargonic acid and at least one selective herbicide compound selected from the group consisting of fluroxypyr, aminopyralid, triclopyr, clopyralid, florasulam, flazasulfuron and prosulfuron: more preferably at least one selective herbicide compound selected from the group consisting of fluroxypyr-meptyl, aminopyralid, triclopyr, florasulam, prosulfuron, diflufenican and dicamba.

Controlling or modifying effects include all deviation from natural development, for example: killing, retardation, leaf burn, albinism, dwarfing, germination prevention and the like. For example, diquat plants that are not killed are often stunted and non-competitive with flowering disrupted. The term ‘plants’ refers to all physical parts of a plant, including seeds, seedlings, saplings, roots, tubers, stems, stalks, foliage and fruits.

The aqueous spray composition used in the method of the invention can be prepared on site by the end-user shortly before application to the foliage of the unwanted dicot plant to be managed or controlled by mixing a pelargonic acid containing composition with a composition containing at least one herbicide compound selected from the group consisting of a pyridyloxy-carboxylate-auxin mimic, an acetolactate synthase inhibitor, a carotenoid biosynthesis inhibitor and a benzoate-auxin mimic and, optionally, a suitable surfactant or adjuvant. Such compositions are typically referred to as “tank-mix” compositions. Suitable tank mix compositions can be prepared from mixing commercially available compositions of the active components. Examples of suitable commercial formulations include: Katoun® (an emulsifiable concentrate (EC) formulation of pelargonic acid) (Belchim Crop Protection); HERBATAK ULTRA™ (an emulsifiable concentrate (EC) formulation of pelargonic acid) (Evergreen Garden Care); Parsec® (a water dispersible granule (WG) formulation of prosulfuron and dicamba) (Syngenta); Hurricane® (a suspension concentrate (SC) of diflufenican) (Adama); Garlon® Ultra (a soluble concentrate of aminopyralid and triclopyr) (Corteva); and Valentia™ (a suspo-emulsion (SE) formulation of florasulam and fluroxypyr) (Barclay Chemicals).

Alternatively, the compositions used in the method of the invention may be provided to the end-user already formulated, at the desired dilution for application (“ready to use” compositions) or supplied in a pre-built concentrate format that requires dilution, dispersion, or dissolution in water by the end-user (“concentrate” compositions). The ready-to-use format is particularly suitable for the consumer market. The concentrate formulation may be used in either the consumer market or the professional market, as well. Such preformulated concentrates can be liquids or particulate solids.

The aqueous spray composition useful in the inventive method is generally formulated in various ways using formulation adjuvants, such as carriers, solvents and surface-active substances. Concentrate compositions can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). As noted above, such compositions can either be used directly or diluted prior to use by tank mix. The dilutions can be made, for example, with water, liquid fertilisers, micronutrients, biological organisms, oil or solvents.

The aqueous spray compositions can be prepared e.g. by mixing the pelargonic acid and the at least one non-selective herbicide (“active ingredients”) with the formulation adjuvants in order to obtain compositions in the form of finely divided solids, granules, solutions, dispersions, emulsions microemulsions or suspo-emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the aqueous spray compositions used in the method of the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in Mccutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10th Edition, Southern Illinois University, 2010.

The compositions useful in the method of the invention generally comprise from 0.1 to 99% by weight, especially from 0.1 to 95% by weight, of active ingredients and from 1 to 99.9% by weight of a formulation adjuvant which preferably includes from 0 to 25% by weight of a surface-active substance. Whereas commercial products used for tank mix may preferably be formulated as concentrates, the aqueous spray composition applied by the end user will normally employ dilute formulations.

The aqueous spray composition used in the method is applied as a post-emergence aqueous spray application accomplished in a customary manner (watering, spraying, atomizing), including a post-emergence aqueous foliar spray application. In the context of the present invention, the term “post-emergence” is taken to mean that the spray composition is applied once the target dicot plant has emerged from the locus. The emerged target dicot plants will include growing plants and established plants. The pelargonic acid and the at least one herbicide compound selected from the group consisting of a pyridyloxy-carboxylate-auxin mimic, an acetolactate synthase inhibitor, a carotenoid biosynthesis inhibitor, and a benzoate-auxin mimic are applied simultaneously, or may be applied sequentially to the locus (in any order). In this instance the components are typically applied within 3 days and most preferably within 24 hours of each other. Suitably, all the components are administered within a timescale of a few hours, such as one hour. Alternatively, and preferably, the individual components are applied simultaneously by aqueous spray application in a single herbicidal aqueous spray composition to a locus. If the components are sprayed simultaneously, they may be administered separately or as a tank mix or as a pre-formulated mixture of all the components or as a pre-formulated mixture of some of the components which are then tank mixed with the remaining components.

In a preferred embodiment, the method for controlling unwanted dicot plants at a locus comprises applying a dicot plant controlling amount of an aqueous spray composition to the foliage of the unwanted dicot plants that have emerged, are growing, or are established at a locus. The method of the present invention also is useful for the spot treatment of dicot weeds growing at a locus, or for clearing all the dicot vegetation from a locus.

In one embodiment, with respect to a particular locus, the method of the present invention can be carried out with an application program comprising 4 spray applications with a 7-day interval between the 1st and the 2nd, and a 60-day interval before the 3rd and 4th application. In another embodiment, the method of the present invention can be carried out with an application program comprising one spray application per season for post-emergent dicot weed control.

In another embodiment, the season for post-emergent dicot weed control with the method of invention is during the spring to early fall time frame with a 10-month buffer between application programs. For example, in the UTC+01:00 time zone the season for post-emergent dicot weed control with the method of invention is from March/April to August/September with a 10-month buffer between application programs.

The method of the invention may be used against many unwanted dicot plants including herbaceous broadleaf weeds, brush, bramble, shrubs, and woody weeds. Preferably, the method of the invention may be used against unwanted dicot plants including brambles, thistles and woody weeds. More preferably, the method of the invention may be used against unwanted dicot plants including brambles and woody weeds.

By way of example, unwanted dicot plants to be managed or controlled by the method of the invention include those from the genera Abutilon, Achillea, Amaranthus, Ambrosia, Anthemis, Bellis, Carduus, Cassia, Centaurea, Chenopodium, Cirsium, Convolvulus, Datura, Emex, Epilobium, Erigeron, Galeopsis, Galinsoga, Galium, Ipomoea, Lamium, Lepidium, Lindernia, Lotus, Matricaria, Papaver, Plantago, Polygonum, Portulaca, Prunus, Quercus, Ranunculus, Rorippa, Rotala, Rubus, Rumex, Scabiosa, Senecio, Sesbania, Sinapis, Solanum, Sonchus, Sphenoclea, Stellaria, Taraxacum, Trifolium, Urtica, Veronica, Viola, Xanthium.

Specific dicot plants that may be mentioned include, for example, Scabiosa columbaria, Plantago lanceolata, Taraxacum officinale, Rubus fructicosu, Senecio inaequidens, Erigeron canadensis, Bellis perennis and Prunus spinosa.

Controlling means killing, damaging, or inhibiting the growth of the dicot plants including herbaceous broadleaf weeds, brush, bramble, shrubs, and woody weeds. In one embodiment, the term “locus” also is intended to include soil, seeds, and seedlings, as well as established vegetation.

Various aspects and embodiments of the present invention will now be illustrated in more detail by way of example. It will be appreciated that modification of detail may be made without departing from the scope of the invention.

### EXAMPLES 1-3

Field studies were conducted to evaluate the response of dicot weeds Plantago lanceolata (PLALA), Taraxacum officinale (TAROF), and Scabiosa columbaria (SCBCO) to the following herbicide treatments:

| | | Total Water |
|---|---|---|
| Treatment | Aqueous Spray Composition | volume |
| Spray Treatment 1 | 196 g/ha fluroxypyr and | 200 l/ha |
| | 4.9 g/ha flurasulam* | |
| Spray Treatment | Spray Treatment 1 + Pelargonic | 200 l/ha |
| 2 | acid 1696.5 g/ha^{±} | |
| Spray Treatment | Spray Treatment 1 + Pelargonic | 200 l/ha |
| 3 | acid 2,827.5 g/ha^{±} | |
| Spray Treatment | Spray Treatment 1 + Pelargonic | 200 l/ha |
| 4 | acid 5655 g/ha^{±} | |

*Spray composition prepared from a suspo-emulsion (SE) formulation comprising 98 g/l Fluroxypyr and 2.45 g/l Flurasulam (2.0 l/ha).
^{±}Spray composition prepared from a mixture of spray composition 1 with an emulsifiable concentrate (EC) formulation comprising 565.49 g/l pelargonic acid (3.0, 5.0 and 10.0 l/ha, respectively)

The trial was conducted on weeds under development. Application was performed in post-emergence with a sprayer type ETC (spray jet) equipped with a spray boom and fitted with flat nozzles. The spray volume per hectare used is 200 L/ha. Frequency of assessment: At TO, evaluation in each elementary plot of coverage by weed or counting by weed, and overall coverage is made. Evaluation in each elementary plot of a visual efficacy per weed and on overall coverage at T+1 day, T+3 days, T+7d, T+14d, T+21d, T+28 days after treatment (DAT).

Individual plot information

| Test plot surface | 8 m² |
|---|---|
| Treated surface | 8 m² |
| Test plot length | 4 m |
| Test plot width | 2 m |
| Replications per treatment | 4 |

### Example 1

TABLE 1
results SCBCO

| DAT | Treatment 1 | Treatment 2 | Treatment 3 | Treatment 4 |
|---|---|---|---|---|
| T + I | 0 | 0 | 10 | 15 |
| T + 3 | 6 | 13 | 18 | 20 |
| T + 7 | 18 | 20 | 33 | 30 |
| T + 14 | 25 | 50 | 53 | 53 |
| T + 21 | 5C | 78 | 65 | 81 |
| T + 28 | 60 | 78 | 70 | 88 |

### Example 2

TABLE 2
results PLALA

| DAT | Treatment 1 | Treatment 2 | Treatment 3 | Treatment 4 |
|---|---|---|---|---|
| T + 1 | 0 | 8 | 18 | 40 |
| T + 3 | 20 | 30 | 18 | 38 |
| T + 7 | 25 | 33 | 43 | 58 |
| T + 14 | 55 | 58 | 70 | 73 |
| T + 21 | 68 | 68 | 80 | 85 |
| T + 28 | 75 | 68 | 84 | 85 |

### Example 3

TABLE 3
results TAROF

| DAT | Treatment 1 | Treatment 2 | Treatment 3 | Treatment 4 |
|---|---|---|---|---|
| T + 1 | 0 | 5 | 20 | 48 |
| T + 3 | 23 | 33 | 33 | 53 |
| T + 7 | 30 | 25 | 40 | 60 |
| T + 14 | 48 | 55 | 70 | 68 |
| T + 21 | 70 | 75 | 83 | 85 |
| T + 28 | 70 | 75 | 85 | 88 |

### EXAMPLES 4-7

### Test Substances:

| | |
|---|---|
| Test Product | Active substance(s) |
| Hurricane | 500 g/L Diflufenican |
| Parsec | 50 g/kg Prosulfuron & 500 g/kg Dicamba |
| Valentia | 144 g/L Fluoroxypyr-meptyl, 2 g/LFlorasulam |
| Garlon Ultra | 12 g ae/L Aminopyralid, 120 g ae/L Triclopyr |
| Herbatak Ultra (HBU) | 565.49 g/L Pelargonic acid |

### Treatment List and Application Details

| Trt | | | Application | Application |
|---|---|---|---|---|
| No. | Treatment | Dose rate | Rate | Timing |
| 1 | Untreated | — | — | — |
| 2 | Parsec + Hurricane | 0.3 kg/ha + | 200 L/ha | A |
| | | 0.25 L/ha | | |
| 3 | Valentia | 2 L/ha | 200 L/ha | |
| 4 | Garlon Ultra | 4 L/ha | 200 L/ha | |
| 5 | Parsec + Hurricane + | 0.3 kg/ha + | 200 L/ha | A |
| | Herbatak Ultra | 0.25 L/ha + | | |
| | | 10 L/ha | | |
| 6 | Valentia + | 2 L/ha + 10 L/ha | 200 L/ha | A |
| | Herbatak Ultra | | | |
| 7 | Garlon Ultra + | 4 L/ha + 10 L/ha | 200 L/ha | |
| | Herbatak Ultra | | | |
| 8 | Parsec + Hurricane + | 0.3 kg/ha + | 200 L/ha | A |
| | Herbatak Ultra | 0.25 L/ha + | | |
| | | 5 L/ha | | |
| 9 | Valentia + | 2 L/ha + 5 L/ha | 200 L/ha | A |
| | Herbatak Ultra | | | |
| 10 | Garlon Ultra + | 4 L/ha + 5 L/ha | 200 L/ha | A |
| | Herbatak Ultra | | | |

Brambles (Rubus fruticosus) were assessed for the % cover at DAT0.

All foliar applications were applied using a Cooper Pegler pressurised knapsack sprayer with flat fan nozzle for application. All spray equipment was fully calibrated prior to use.

Each treatment comprised of four replicates, with each replicate plot covering an area of 10 m² (2 m×5 m). Plots were arranged in a randomised block design.

An assessment of the % cover of brambles (Rubus fruticosus) was made prior to the initial application. A total of six assessments including % cover and percentage control of brambles (Rubus fruticosus) were made during the course of the trial: 0DAA, 6DAA, 11DAA, 28DAA, 62DAA and 91DAA.

All statistical analyses were performed using ARM (version 21.5). One-way ANOVAs were performed at each assessment interval for the % cover and % visual control for each weed species and total weeds. Student Newman Kuels comparison tests were used to distinguish between means where appropriate and these are indicated by a letter test; treatments with no letters in common are significantly different. In all analyses, the probability of no significant differences occurring between treatments was calculated as the F probability value (p (F)). All tests were undertaken at the 95% confidence interval. Residuals were tested for normality where P>0.05 indicated normal distribution.

### Examples 4-5 Conditions at Application

| | | Cloud | Wind | | | |
|---|---|---|---|---|---|---|
| Temp. | Humidity | Cover | Speed | Wind | Crop | Soil |
| (° C.) | (%) | (%) | (m/s) | direction | surface | surface |
| 25.3 | 45 | 95 | 2.1 | NE | Dry | Dry |
| | | | | | | (22° C.) |

### Example 4: Rubus fruticosus % Cover (n=4) (One-Way ANOVA)

| | | | | | | |
|---|---|---|---|---|---|---|
| Pest Type | W, Weed | W, Weed | W, Weed | W, Weed | W, Weed | W, Weed |
| Pest Code | RUBFR | RUBFR | RUBFR | RUBFR | RUBFR | RUBFR |
| Pest Scientific Name | Rubus | Rubus | Rubus | Rubus | Rubus | Rubus |
| | fruticosus | fruticosus | fruticosus | fruticosus | fruticosus | fruticosus |
| Pest Name | blackberry | blackberry | blackberry | blackberry | blackberry | blackberry |
| Description | % Cover | % Cover | % Cover | % Cover | % Cover | % Cover |
| | RUBFR | RUBFR | RUBFR | RUBFR | RUBFR | RUBFR |
| Assessment Timing | A0 | A1 | A2 | A3 | A4 | A5 |
| Days After First/Last | 0, 0 | 6, 6 | 11, 11 | 28, 28 | 62, 62 | 91, 91 |
| Applic. | | | | | | |
| Trt-Eval Interval | 0 DA-A | 6 DA-A | 11 DA-A | 28 DA-A | 62 DA-A | 91 DA-A |

| Trt | Treatment | Rate Appl | | | | | | | | |
|---|---|---|---|---|---|---|---|---|---|---|
| No. | Name | Rate Unit | | Code | | | | | | |
| 1 | Untreated | | | | 34.0a | 36.3a | 35.0a | 58.8a | 70.0a | 75.0a |
| 3 | Parsec | 0.3 | kg/ha | A | 36.3a | 36.3a | 36.3a | 42.5ab | 33.8ab | 48.8abc |
| | Hurricane | 0.25 | l/ha | A | | | | | | |
| 4 | Valentia | 2 | l/ha | A | 48.8a | 43.8a | 43.8a | 25.0ab | 20.0b | 20.0bc |
| 5 | Garlon Ultra | 4 | l/ha | A | 33.8a | 31.3a | 30.0a | 13.8b | 17.5b | 23.8bc |
| | HBU | 10 | l/ha | A | | | | | | |
| 7 | Parsec | 0.3 | kg/ha | A | 37.5a | 31.3a | 31.3a | 28.8ab | 28.8b | 36.3bc |
| | Hurricane | 0.25 | l/ha | A | | | | | | |
| | HBU | 10 | l/ha | A | | | | | | |
| 8 | Valentia | 2 | l/ha | A | 33.0a | 30.0a | 30.0a | 15.0b | 8.8b | 10.0c |
| | HBU | 10 | l/ha | A | | | | | | |
| 9 | Garlon Ultra | 4 | l/ha | A | 30.3a | 28.8a | 28.0a | 26.3ab | 23.8b | 26.3bc |
| | HBU | 10 | l/ha | A | | | | | | |
| | HBU | 5 | l/ha | A | | | | | | |
| 11 | Parsec | 0.3 | kg/ha | A | 18.5a | 18.0a | 16.8a | 8.8b | 8.8b | 7.5c |
| | Hurricane | 0.25 | kg/ha | A | | | | | | |
| | HBU | 5 | l/ha | A | | | | | | |
| 12 | Valentia | 2 | l/ha | A | 27.5a | 27.5a | 28.8a | 11.3b | 11.3b | 12.5bc |
| | HBU | 5 | l/ha | A | | | | | | |
| 13 | Garlon Ultra | 4 | l/ha | A | 26.3a | 25.0a | 20.0a | 17.5ab | 16.3b | 8.8c |
| | HBU | 5 | l/ha | A | | | | | | |

| | | | | | | |
|---|---|---|---|---|---|---|
| LSD P = .05 | 20.64 | 19.61 | 21.70 | 25.62 | 26.11 | 26.02 |
| Standard Deviation | 14.43 | 13.71 | 15.17 | 17.92 | 18.25 | 18.19 |
| CV | 43.12 | 42.89 | 49.48 | 65.84 | 64.35 | 56.48 |
| Levene's F | 0.434 | 0.461 | 0.632 | 0.827 | 0.831 | 0.569 |
| Skewness | 0.3804 | 0.3598 | 0.2521 | 1.0619* | 0.9575* | 0.6103 |
| Kurtosis | −0.4671 | −0.3716 | −0.6507 | 0.5579 | −0.0011 | −0.8604 |
| Treatment F | 1.044 | 0.965 | 0.852 | 2.674 | 3.937 | 5.468 |
| Treatment Prob(F) | 0.4306 | 0.4969 | 0.5993 | 0.0101 | 0.0006 | 0.0001 |

### Example 5: Rubus fruticosus % Control (n=4) (One-Way ANOVA)

| | | | | | |
|---|---|---|---|---|---|
| Pest Type | W, Weed | W, Weed | W, Weed | W, Weed | W, Weed |
| Pest Code | RUBFR | RUBFR | RUBFR | RUBFR | RUBFR |
| Pest Scientific Name | Rubus | Rubus | Rubus | Rubus | Rubus |
| | fruticosus | fruticosus | fruticosus | fruticosus | fruticosus |
| Pest Name | blackberry | blackberry | blackberry | blackberry | blackberry |
| Description | % Cover | % Cover | % Cover | % Cover | % Cover |
| | RUBFR | RUBFR | RUBFR | RUBFR | RUBFR |
| Assessment Timing | A1 | A2 | A3 | A4 | A5 |
| Days After First/Last | 6, 6 | 11, 11 | 28, 28 | 62, 62 | 91, 91 |
| Applic. | | | | | |
| Trt-Eval Interval | 6 DA-A | 11 DA-A | 28 DA-A | 62 DA-A | 91 DA-A |

| Trt | Treatment | Rate Appl | | | | | | | |
|---|---|---|---|---|---|---|---|---|---|
| No. | Name | Rate Unit | | Code | | | | | |
| 1 | Untreated | | | | 0.0d | 0.0b | 0.0b | 0.0c | 0.0b |
| 3 | Parsec | 0.3 | kg/ha | A | 11.3cd | 13.8ab | 47.5a | 62.0ab | 21.3ab |
| | Hurricane | 0.25 | l/ha | A | | | | | |
| 4 | Valentia | 2 | l/ha | A | 27.5abc | 30.0ab | 90.0a | 94.8a | 65.8ab |
| 5 | Garlon Ultra | 4 | l/ha | A | 25.0abc | 27.5ab | 85.0a | 76.5ab | 42.5ab |
| | HBU | 10 | l/ha | A | | | | | |
| 7 | Parsec | 0.3 | kg/ha | A | 43.8a | 46.3a | 78.8a | 75.8ab | 30.0ab |
| | Hurricane | 0.25 | l/ha | A | | | | | |
| | HBU | 10 | l/ha | A | | | | | |
| 8 | Valentia | 2 | l/ha | A | 31.3abc | 27.5ab | 81.3a | 98.5a | 55.0ab |
| | HBU | 10 | l/ha | A | | | | | |
| 9 | Garlon Ultra | 4 | l/ha | A | 25.0abc | 21.3ab | 57.5a | 68.3ab | 40.0ab |
| | HBU | 10 | l/ha | A | | | | | |
| | HBU | 5 | l/ha | A | | | | | |
| 11 | Parsec | 0.3 | kg/ha | A | 23.8abc | 32.5ab | 81.3a | 78.8ab | 15.0ab |
| | Hurricane | 0.25 | kg/ha | A | | | | | |
| | HBU | 5 | l/ha | A | | | | | |
| 12 | Valentia | 2 | l/ha | A | 15.0bcd | 15.0ab | 90.0a | 93.3a | 42.0ab |
| | HBU | 5 | l/ha | A | | | | | |
| 13 | Garlon Ultra | 4 | l/ha | A | 35.0ab | 53.8a | 78.8a | 79.5ab | 78.3a |
| | HBU | 5 | l/ha | A | | | | | |

| | | | | | |
|---|---|---|---|---|---|
| LSD P = .05 | 13.81 | 24.74 | 32.41 | 37.00 | 40.68 |
| Standard Deviation | 9.66 | 17.30 | 22.66 | 25.87 | 28.45 |
| CV | 43.67 | 63.57 | 34.61 | 40.07 | 90.36 |
| Levene's F | 3.003* | 1.219 | 1.92 | 1.555 | 4.072* |
| Skewness | 0.6138 | 1.0503* | −0.8513* | −0.6895* | 0.9339* |
| Kurtosis | 0.0544 | 0.9852 | −0.5372 | −1.0136 | −0.609 |
| Treatment F | 5.477 | 2.702 | 5.100 | 5.140 | 3.078 |
| Treatment Prob(F) | 0.0001 | 0.0094 | 0.0001 | 0.0001 | 0.0039 |

### Examples 6-7 Conditions at Application

| | | Cloud | Wind | | | |
|---|---|---|---|---|---|---|
| Temp. | Humidity | Cover | Speed | Wind | Crop | Soil |
| (° C.) | (%) | (%) | (m/s) | direction | surface | surface |
| 17.5 | 60 | 80 | 3 | W | Dry | Moist |
| | | | | | | (15° C.) |

### Example 6: Rubus fruticosus % Cover (n=4) (One-Way ANOVA)

| | | | | | | |
|---|---|---|---|---|---|---|
| Pest Type | W, Weed | W, Weed | W, Weed | W, Weed | W, Weed | W, Weed |
| Pest Code | RUBFR | RUBFR | RUBFR | RUBFR | RUBFR | RUBFR |
| Pest Scientific | Rubus | Rubus | Rubus | Rubus | Rubus | Rubus |
| Name | fruticosus | fruticosus | fruticosus | fruticosus | fruticosus | fruticosus |
| Pest Name | blackberry | blackberry | blackberry | blackberry | blackberry | blackberry |
| Description | % Cover | % Cover | % Cover | % Cover | % Cover | % Cover |
| | RUBFR | RUBFR | RUBFR | RUBFR | RUBFR | RUBFR |
| Assessment Timing | A0 | A1 | A2 | A3 | A4 | A5 |
| Days After First/Last | 0, 0 | 8, 8 | 14, 14 | 28, 28 | 59, 59 | 91, 91 |
| Applic. | | | | | | |
| Trt-Eval Interval | 0 DA-A | 8 DA-A | 14 DA-A | 28 DA-A | 59 DA-A | 91 DA-A |

| Trt | Treatment | Rate Appl | | | | | | | | |
|---|---|---|---|---|---|---|---|---|---|---|
| No. | Name | Rate Unit | | Code | | | | | | |
| 1 | Untreated | | | | 28.0a | 28.0a | 31.3a | 43.8a | 48.8a | 56.3a |
| 2 | Vivendi | 1 | l/ha | A | 26.3a | 26.3a | 22.5a | 25.0a | 26.3a | 35.0a |
| 3 | Parsec | 0.3 | kg/ha | A | 31.3a | 31.3a | 26.3a | 26.3a | 28.8a | 42.5a |
| | Hurricane | 0.25 | l/ha | A | | | | | | |
| 4 | Valentia | 2 | l/ha | A | 32.5a | 32.5a | 33.8a | 21.3a | 21.3a | 36.3a |
| 5 | Garlon Ultra | 4 | l/ha | A | 31.3a | 30.0a | 20.0a | 27.5a | 22.5a | 40.0a |
| 6 | Vivendi | 1 | l/ha | A | 35.5a | 35.5a | 38.0a | 38.8a | 47.5a | 56.3a |
| | HBU | 10 | l/ha | A | | | | | | |
| 7 | Parsec | 0.3 | kg/ha | A | 28.8a | 27.5a | 35.0a | 31.3a | 35.0a | 41.3a |
| | Hurricane | 0.25 | l/ha | A | | | | | | |
| | HBU | 10 | l/ha | A | | | | | | |
| 8 | Valentia | 2 | l/ha | A | 41.3a | 38.8a | 38.8a | 36.3a | 32.5a | 33.8a |
| | HBU | 10 | l/ha | A | | | | | | |
| 9 | Garlon Ultra | 4 | l/ha | A | 35.5a | 35.0a | 27.5a | 26.3a | 25.0a | 37.5a |
| | HBU | 10 | l/ha | A | | | | | | |
| 10 | Vivendi | 1 | l/ha | A | 18.8a | 18.8a | 24.3a | 23.8a | 32.5a | 35.0a |
| | HBU | 5 | l/ha | A | | | | | | |
| 11 | Parsec | 0.3 | kg/ha | A | 26.0a | 26.8a | 28.8a | 26.3a | 26.3a | 32.5a |
| | Hurricane | 0.25 | kg/ha | A | | | | | | |
| | HBU | 5 | l/ha | A | | | | | | |
| 12 | Valentia | 2 | l/ha | A | 31.8a | 31.3a | 36.3a | 30.0a | 23.8a | 40.0a |
| | HBU | 5 | l/ha | A | | | | | | |
| 13 | Garlon Ultra | 4 | l/ha | A | 25.0a | 22.5a | 18.8a | 31.3a | 11.3a | 30.0a |
| | HBU | 5 | l/ha | A | | | | | | |

| | | | | | | |
|---|---|---|---|---|---|---|
| LSD P = .05 | 27.06 | 27.22 | 29.29 | 28.94 | 28.13 | 28.35 |
| Standard Deviation | 18.92 | 19.03 | 20.48 | 20.23 | 19.66 | 19.82 |
| CV | 62.79 | 64.43 | 69.88 | 67.87 | 67.05 | 49.91 |
| Levene's F | 0.895 | 0.75 | 0.415 | 0.501 | 0.672 | 0.386 |
| Skewness | 0.5786 | 0.5479 | 0.5423 | 0.6683* | 0.6078 | 0.6097 |
| Kurtosis | −0.9883 | −0.9807 | −0.7993 | −0.3445 | −0.4268 | −0.411 |
| Treatment F | 0.360 | 0.328 | 0.439 | 0.404 | 1.093 | 0.679 |
| Treatment Prob(F) | 0.9700 | 0.9793 | 0.9372 | 0.9532 | 0.3928 | 0.7603 |

### Example 7: Rubus fruticosus % Control (n=4) (One-Way ANOVA)

| | | | | | |
|---|---|---|---|---|---|
| Pest Type | W, Weed | W, Weed | W, Weed | W, Weed | W, Weed |
| Pest Code | RUBFR | RUBFR | RUBFR | RUBFR | RUBFR |
| Pest Scientific Name | Rubus | Rubus | Rubus | Rubus | Rubus |
| | fruticosus | fruticosus | fruticosus | fruticosus | fruticosus |
| Pest Name | blackberry | blackberry | blackberry | blackberry | blackberry |
| Description | % Cover | % Cover | % Cover | % Cover | % Cover |
| | RUBFR | RUBFR | RUBFR | RUBFR | RUBFR |
| Assessment Timing | A1 | A2 | A3 | A4 | A5 |
| Days After First/Last | 8, 8 | 14, 14 | 28, 28 | 59, 59 | 91, 91 |
| Applic. | | | | | |
| Trt-Eval Interval | 8 DA-A | 14 DA-A | 28 DA-A | 59 DA-A | 91 DA-A |

| Trt | Treatment | Rate Appl | | | | | | | |
|---|---|---|---|---|---|---|---|---|---|
| No. | Name | Rate Unit | | Code | | | | | |
| 1 | Untreated | | | | 0.0d | 0.0b | 0.0d | 0.0b | 0.0b |
| 2 | Vivendi | 1 | l/ha | A | 2.0d | 39.3ab | 16.3cd | 58.8a | 40.0ab |
| 3 | Parsec | 0.3 | kg/ha | A | 6.8cd | 9.3ab | 11.3cd | 57.5a | 37.5ab |
| | Hurricane | 0.25 | l/ha | A | | | | | |
| 4 | Valentia | 2 | l/ha | A | 0.0d | 35.0ab | 70.0ab | 68.8a | 50.0a |
| 5 | Garlon Ultra | 4 | l/ha | A | 16.3bcd | 57.5ab | 75.0ab | 78.8a | 51.3a |
| 6 | Vivendi | 1 | l/ha | A | 3.0d | 5.0ab | 8.8cd | 38.8ab | 30.0ab |
| | HBU | 10 | l/ha | A | | | | | |
| 7 | Parsec | 0.3 | kg/ha | A | 16.3bcd | 28.8ab | 35.0bcd | 61.3a | 40.0ab |
| | Hurricane | 0.25 | l/ha | A | | | | | |
| | HBU | 10 | l/ha | A | | | | | |
| 8 | Valentia | 2 | l/ha | A | 27.5b | 37.5ab | 48.8abc | 77.5a | 55.0a |
| | HBU | 10 | l/ha | A | | | | | |
| 9 | Garlon Ultra | 4 | l/ha | A | 10.0cd | 55.5ab | 75.0ab | 88.8a | 65.0a |
| | HBU | 10 | l/ha | A | | | | | |
| 10 | Vivendi | 1 | l/ha | A | 4.5d | 17.5ab | 22.5cd | 38.8ab | 35.0ab |
| | HBU | 5 | l/ha | A | | | | | |
| 11 | Parsec | 0.3 | kg/ha | A | 3.5d | 13.8ab | 16.3cd | 70.0a | 42.5ab |
| | Hurricane | 0.25 | kg/ha | A | | | | | |
| | HBU | 5 | l/ha | A | | | | | |
| 12 | Valentia | 2 | l/ha | A | 21.3bc | 42.5ab | 75.0ab | 92.5a | 55.0a |
| | HBU | 5 | l/ha | A | | | | | |
| 13 | Garlon Ultra | 4 | l/ha | A | 57.5a | 71.3a | 88.8a | 87.5a | 42.5ab |
| | HBU | 5 | l/ha | A | | | | | |

| | | | | | |
|---|---|---|---|---|---|
| LSD P = .05 | 10.85 | 39.87 | 30.37 | 32.29 | 28.96 |
| Standard Deviation | 7.58 | 27.87 | 21.24 | 22.58 | 20.25 |
| CV | 58.51 | 87.79 | 50.89 | 35.85 | 48.42 |
| Levene's F | 4.874* | 2.308* | 4.067* | 1.386 | 0.89 |
| Skewness | 2.0999* | 0.6241 | 0.1663 | −0.8662* | −0.5598 |
| Kurtosis | 4.7532* | −1.1791 | −1.7209* | −0.3036 | −0.8098 |
| Treatment F | 17.673 | 2.475 | 8.760 | 5.146 | 2.440 |
| Treatment Prob(F) | 0.0001 | 0.0163 | 0.0001 | 0.0001 | 0.0177 |

As seen in Examples 5-6, Herbatak Ultra (pelargonic acid) (at both 5 L/ha and 10 L/ha) displayed positive effects of herbicides when targeting Rubus fruticosus (bramble), particularly enhancing the performance of Valentia and Parsec+Hurricane, which saw improvements in efficacy through reduced cover of Rubus fruticosus when compared to the herbicides applied as standalone. Herbatak Ultra (pelargonic acid) was also able to provide enhanced % control scores against Rubus fruticosus (which also accounts for visible damage to weeds) for Garlon Ultra. In Examples 7-8 Herbatak Ultra (pelargonic acid) applied at both rates enhanced the performance of Parsec+Hurricane, Valentia and Garlon Ultra in providing higher % control scores against Rubus fruticosus (Bramble), particularly after 28DAA. The results indicate improved control of dicot weeds including bramble and woody weeds in accordance with the method of the invention.

1. A method for controlling dicot weeds at a locus comprising the weeds, which comprises applying to the locus a dicot weed controlling amount of an aqueous spray composition comprising pelargonic acid and a second herbicide selected from fluroxypyr, aminopyralid, triclopyr, florasulam, flazasulfuron and prosulfuron; wherein the spray volume of the aqueous spray composition is from 100 to 500 l/ha and the pelargonic acid is applied at a rate of 0.5 to 6 kg/ha.

2. The method according to claim 1, wherein the second herbicide is selected from fluroxypyr, aminopyralid, triclopyr, florasulam, and prosulfuron

3. The method according to claim 1, wherein the fluroxypyr is applied at a rate of 196-200 g/ha.

4. The method according to claim 1, wherein the florasulam is applied at a rate of 4-6 g/ha.

5. The method according to claim 1, wherein the aminopyralid is applied at a rate of 48-50 g/ha.

6. The method according to claim 1, wherein the prosulfuron is applied at a rate of 15-20 g/ha.

7. The method according to claim 1, wherein the triclopyr is applied at a rate of 400-480 g/ha.

8. The method according to claim 1, wherein the second herbicide is a mixture of fluroxypyr and florasulam

9. The method according to claim 1, wherein the second herbicide is a mixture of prosulfuron, dicamba and diflufenican.

10. The method according to claim 1, wherein the second herbicide is a mixture of aminopyralid and triclopyr.

11. The method according to claim 8, wherein the fluroxypyr is applied at a rate of 196-200 g/ha and the florasulam is applied at a rate of 4-6 g/ha; preferably 196 g/ha fluroxypyr and 4.9 g/ha flurasulam.

12. The method according to claim 10, wherein the aminopyralid is applied at a rate of 48-50 g/ha. and the triclopyr is applied at a rate of 400-480 g/ha.

13. The method according to claim 1, wherein the pelargonic acid is applied at a rate of 1.6 to 6 kg/ha; preferably at a rate of 2 to 6 kg/ha.

14. The method according to claim 1, wherein the spray volume of the aqueous spray composition is from 200 to 400 l/ha.

15. The method according to claim 14, wherein the spray volume of the aqueous spray composition is 200 l/ha.

16. The method according to claim 14, wherein the spray volume of the aqueous spray composition is 400 l/ha.

17. The method according to claim 1, wherein the dicot weed to be controlled is selected from Scabiosa columbaria, Plantago lanceolata, Taraxacum officinale, Rubus fructicosu, Senecio inaequidens, Erigeron canadensis, Bellis perennis and Prumis spinosa.
